(19) United States
(12) Patent Application Publication
(10) Pub. No.: US 2006/0228137 A1
(43) Pub. Date: Oct. 12, 2006

(54) Multiple quantity print job separation systems and methods

(75) Inventor: Darlene Steele, Penfield, NY (US)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(73) Assignee: Xerox Corporation

(21) Appl. No.: 11/103,976

(22) Filed: Apr. 12, 2005

(51) Int. Cl. G03G 15/00

(52) U.S. Cl. 399/382

(57) ABSTRACT

Embodiments herein automatically separate a multiple quantity print job. Instructions to print a plurality of quantities of a single print job are received. The method sequentially prints each of the quantities and automatically inserts a separator sheet between each of the quantities.

### BACKGROUND

The embodiments herein generally relate to separating a multiple quantity print/copy job, and more particularly to a method and system that produces a single output having all of the quantities of the print job separated by separator sheets, without additional user interaction.

Conventional printing and copying systems allow the quantity of a print job to be specified. For example, when a user loads a print job or copy job (which can comprise one or more sheets) into a copier the user is provided the option to specify that more than one copy should be made. Further, many copiers provide peripheral devices to sort, staple, etc. the copies that are produced. Similarly, software programs such as word processors, spreadsheets, personal organizers, etc. include the ability to print multiple copies of a given print job.

As discussed in U.S. Pat. No. 5,316,279, incorporated herein by reference, in modern copiers or printers, cover or slip sheets or other inserts may be automatically added to sets, subsets or chapters by the copier or printer itself feeding the cover stock or other slip sheet from separate supply stacks at the correct times to be automatically interleaved with the normal sequential output of copy sheets, with or without printing thereon. Many copiers or printers can automatically insert colored covers. Automatic selectable cover sheet or tab sheet inserter systems, feeding these special sheets from separate paper feeding trays into job sets are taught. Sheet stacks with some sort of colored separator marker strips or sheets which are manually inserted to stick out of the stack are sometimes used in copy shops.

Further by way of background, unbound sets of copy sheets are difficult to keep tidy and sort or separate from each other. As noted above, it is fairly common for copiers and printers to provide relative offsetting of sequential unbound copy sets which are otherwise being commonly stacked, so as to facilitate separation and sorting.

As xerographic and other copiers and printers increase in speed, and become more automatic, it is increasingly important to provide higher speed, more reliable and more automatic handling of the copy sheets being copied or printed, i.e., the rapidly accumulating output of the copier or printer. Thus, it is even more important to better segregate separate sets of output copies, even if the copier or printer is a stand-alone unit rather than a network sharing unit.

### SUMMARY

A method embodiment for automatically separating a multiple quantity print job, as described herein, can receive instructions to print a plurality of quantities of a single print job. These “quantities” comprise different numbers of copies of the single print job, where the “single print job” comprises one or more documents, each of which can be a single page or multiple pages that are bound or unbound. The method sequentially prints each of the quantities of copies and automatically inserts a separator sheet between each of the quantities of copies. More specifically, this process involves printing a first of the quantities, automatically inserting a separator sheet after printing the first quantity, and then repeating the printing and inserting of the separator sheet sequentially for all remaining quantities.

This process can be performed using a single printing engine. The separator sheet is distinguishable from sheets used for the printing, and can include identifying information, such as the recipient or delivery location for that quantity of the print job.

One feature of the method embodiment is that the user can input all of the different quantities of copies that are required, before beginning the printing and separator sheet insertion process. Therefore, the method embodiment is completely autonomous once the user loads the print job and identifies the different quantities of the print job to be printed or copied. Thus, after the user starts the printing process, the printing engine produces a single output having all of the quantities of the print job separated by separator sheets, without additional user interaction.

Also included herein is a system embodiment that includes a graphic user interface adapted to receive the instructions to print a plurality of quantities of a single print job, and a single printing engine that includes or is in communication with the graphic user interface. The printing engine sequentially prints each of the quantities and automatically inserts a separator sheet between each of the quantities. The single printing engine has at least one marking engine and a single output that can be connected to peripherals such as sorter, stapler, envelope processor, etc. The graphic user interface is adapted to receive all of the quantities before the printing engine sequentially prints the quantities. Again, by sequentially printing the single print job and automatically inserting the separator sheet, the printing engine produces a single output (e.g., one or more bound or unbound stacks of document sheets) having all of the quantities of the print job separated by separator sheets.

These and other features are described in, or are apparent from, the following detailed description.

### BRIEF DESCRIPTION OF THE DRAWINGS

Various exemplary embodiments of the systems and methods described in detail below, with reference to the attached drawing figures, in which:

FIG. 1 is a flowchart illustrating a method embodiment;

FIG. 2 is a schematic representation of a multiple quantity print job separated using separator sheets;

FIG. 3 is a schematic representation of a screenshot for entering different quantities for a multiple quantity print job;

FIG. 4 is a schematic representation of a printing engine according to embodiments herein; and

FIG. 5 is a schematic representation of a printing engine according to embodiments herein.

### DETAILED DESCRIPTION

As mentioned above, conventional printing and copying systems allow multiple copies of a print or copy job to be produced; however, if multiple different quantities of the same print job or copy job were needed conventionally, multiple jobs needed to be processed through the printer or copier. In other words, conventionally each copy/print job was limited to only one quantity. This conventional structure limits the ability to print or copy a document (or group of documents that make up the print job) to many different size groups. For example, if a print job (document or group of documents) needs to be distributed to 25 different groups (where at least two of the groups need a different quantity of the print job) this would conventionally require 25 separate print or copy instructions to be prepared by the user. Alternatively, the user can print or copy the entire number of copies of the print job in a single print instruction and then manually divide the output. However, both operations are cumbersome and time intensive.

For example, in an educational environment where a print job needs to be provided to many different classes of varying size, conventional systems either required a separate print job for each class or manually dividing a single print job according to the different class sizes. Alternatively, one print job could be made for the largest class and then that print job could be copied for each other class, thereby producing more copies than needed for any class that is smaller than the largest class.

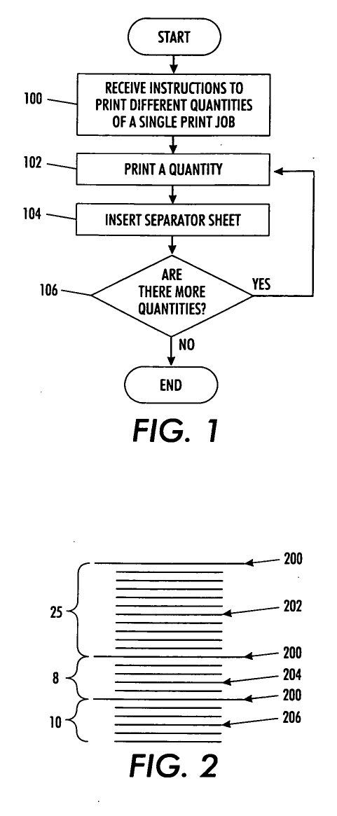

The embodiments herein provide the user with the ability to input multiple quantities (and quantity identifiers) to allow a printing engine to automatically insert separator sheets between different quantities of the same print job, without additional user intervention. More specifically, FIG. 1 is a flowchart illustrating a method embodiment that automatically separates a multiple quantity print job without requiring user intervention to separate the different quantities of the print job. As shown in item 100, instructions to print a plurality of quantities of a single print job are received. These “quantities” comprise different numbers of copies of the single print job, where the “single print job” comprises one or more documents (e.g., a complex print job), each of which can be a single page or multiple pages that are bound or unbound. The method then sequentially prints each of the quantities and automatically inserts a separator sheet between each of the quantities. More specifically, this process involves printing a first of the quantities in item 102, automatically inserting of a separator sheet after printing the first quantity in item 104, and then repeating the printing and inserting the separator sheet for all remaining quantities, as shown by item 106. This process can be performed using a single printing engine or multiple printing engines.

As shown in FIG. 2, the separator sheet 200 is distinguishable from sheets 202, 204, 206 used for printing the different quantities of the single print job. The separator sheet 200 can be a different size, different color, different thickness, etc. than the sheets used for printing so that the separator can be easily visually and/or tactilely identified. Further, the separator sheet 200 can include identifying information, such as the recipient or delivery location for that quantity of the print job, as well as the number of copies that are within the quantity located below (or above) the separator sheet. This allows the operator to know which destination is to receive the sheets immediately below (above) a given separator, and provides the operator with some idea of how many copies are included within the quantity, to help insure that each intended recipient receives the number of copies intended for them.

Any type of separator sheet or separator mechanism can be utilized with embodiments herein. Conventional systems allowed whole print jobs to be separated by separator sheets. For example, U.S. Pat. No. 5,316,279 (incorporated herein by reference) describes providing useful job set and user identity identification by the use of specially printed words, numbers, bar codes, colors, aperture patterns, or other marking indicia on the separate sheets. Thus, quantities may be readily delineated from one another by indicia which are readily visible. Thus, desirably, multiple quantities of a job can be collected in simple common output trays, and/or fed into boxes or containers corresponding to the dimensions of standard copy sheets, with all of the sets neatly stacked therein to the same edge alignment, without confusion between the sets or quantities. By way of background art in that regard as to bar code job identifier printing or sheet insertion controls in a copier or printer, there is noted U.S. Pat. No. 4,602,776 and particularly U.S. Pat. No. 4,970,554 and also U.S. Pat. No. 4,757,348 and U.S. Pat. and No. 4,987,447.

While the foregoing discusses the use of separator sheets, an additionally (optional and/or alternative) disclosed feature here is a two-way or reversible paper tray or cassette in machine which allows sheets to be fed either short edge or long edge first into the copier or printer. This allows the same size sheet to be fed, but fed at 90° to the job sheets as described in U.S. Pat. No. 5,316,279. One example of a rotatable or two-way mounting paper cassette is disclosed in U.S. Pat. No. 4,826,147, also incorporated herein by reference.

Further, FIG. 2 illustrates three different quantities 202, 204, and 206 that are included within the same print job. Quantity 202 includes 25 copies of the print job; quantity 204 includes 8 copies of the print job; and quantity 206 includes 10 copies of the print job. While embodiments herein described limited numbers of quantities and limited numbers of copies within each quantity, one ordinarily skilled in the art would understand that there is no limit to the number of quantities or the number of copies that can be specified by the user (within mechanical limits of the printing engine). Therefore, the number of quantities and copies used herein is merely exemplary and the invention is not limited to any specific quantity or number of copies.

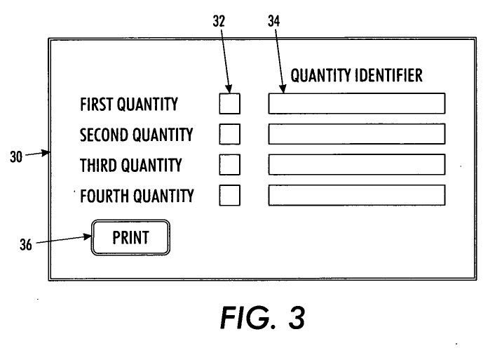

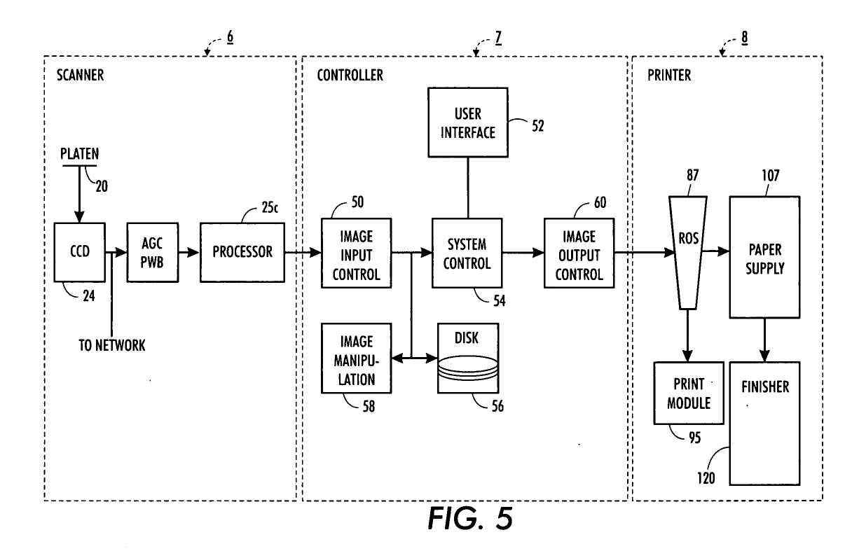

As illustrated in FIG. 3, one feature of the embodiments herein is that the user can input all of the different quantities of a single print job that are required, before beginning the printing and separator sheet insertion process. More specifically, FIG. 3 illustrates a screen shot 30 that could be displayed on the graphic user interface, (shown in FIG. 5 below), when the user indicates that the print job will have multiple quantities that should be handled differently. In item 32, the user is permitted to enter a number for the first quantity. Item 32 represents the number of copies of the print job that will be included within the first quantity. In addition, item 34 represents a quantity identifier that can be printed on the separator sheet 200 identify the recipient or destination of the first quantity. Item 36 represents a print button that the user can activate after providing data in items 32 and 34. The method embodiment is completely autonomous once the user loads the print job, identifies the different quantities 32 of the print job to be printed or copied and the quantity identifiers 34, and activates the print button 36. After the user starts the printing process by activating the print button 36, the printing engine produces a single output having all of the quantities of the print job separated by separator sheets (as shown in FIG. 2), without any additional user interaction being required.

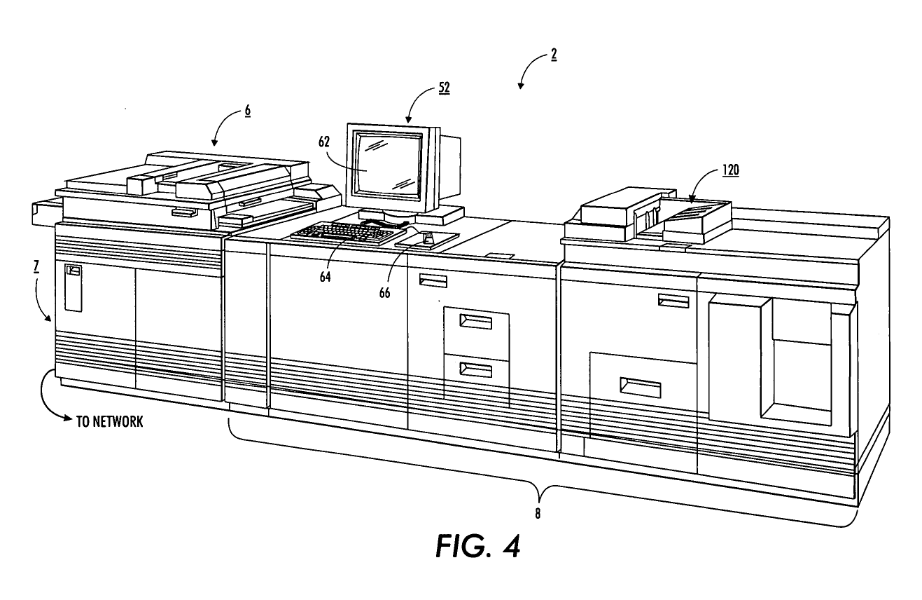

Turning now to FIGS. 4 and 5 there is shown an exemplary electronic reprographic system 2 for processing print jobs (with corresponding job programming) in accordance with the teachings hereof. Reprographic system 2, for purposes of explanation, is divided into a scanner section 6, controller section 7, and printer section 8. Referring to the illustrated embodiment of FIG. 5, scanner section 6 incorporates a conventional image capture platform of the type disclosed in U.S. Pat. No. 5,442,732, the disclosure of which is incorporated herein by reference. The scanner 6 may include linear arrays (not shown) for capturing analog image signals or pixels representative of an image scanned which, after suitable processing by processor 25, are output to controller section 7. Processor 25 converts the analog image signals output by array 24 to digital image signals and processes the image signals as required to enable reprographic system 2 to store and handle the image signals or data in the form required to carry out the job programmed. Processor 25 also provides enhancements and changes to the image signals, such as filtering, thresholding, screening, cropping, and reduction/enlarging.

In the exemplary reprographic system 2 (FIG. 6), printer section 8 comprises a laser type printer and, for purposes of explanation, is separated into a Raster Output Scanner (ROS) section 87, print module section 95, paper supply section 107, and high speed finisher 120. It should be appreciated that the high speed finisher 120 could comprise one or more inline or offline finishers. Finally, in the exemplary reprographic system 2, controller section 7 is, for explanation purposes, divided into an image input controller 50, User Interface (UI) 52, system controller 54, main memory 56, image manipulation section 58, and image output controller 60.

As best seen in the illustrated embodiment of FIG. 5, UI 52 controls a combined operator controller/CRT display consisting of an interactive display screen (e.g. touchscreen) 62, keyboard 64, and mouse 66. UI 52 interfaces the operator with reprographic system 2, enabling the operator to program print jobs and other instructions (as will be discussed in further detail below) and to obtain system operating information, instructions, programming information, and diagnostic information. Items displayed on display screen 62, such as files and icons, are actuated by either touching the displayed item on display screen 62 with a finger or by using mouse 66 to point a cursor to the item selected and keying the mouse 66.

When the image data of main memory 56 requires further processing or is required for display on touchscreen 62 of UI 52, or is required by printer section 8, the data is accessed in main memory 56. Where further processing other than that provided by processor 25 is required, the data is transferred to image manipulation section 58 where the additional processing steps such as collation, make ready, and cropping are carried out. Following processing, the data may be returned to main memory 56, sent to UI 52 for display on touchscreen 62, or sent to image output controller 60.

Thus, as shown in FIGS. 4 and 5, a system environment includes the graphic user interface 52 working with the processor 7 that are adapted to receive the instructions to print a plurality of quantities of a single print job, and the single printing engine 8 that includes, or is in communication, with the graphic user interface 52. As controlled by the processor 7, the printing engine 8 sequentially prints each of the quantities and automatically inserts a separator sheet 200 between each of the quantities. The single printing engine 8 has at least one marking engine 95 and a single output that can be connected to peripherals such as sorter, stapler, envelope processor, etc. The graphic user interface 52 is adapted to receive all of the quantities before the printing engine 8 sequentially prints the quantities. Again, by sequentially printing the single print job and automatically inserting the separator sheet, the printing engine 8 produces a single output (e.g., one or more bound or unbound stacks of document sheets) having all of the quantities of the print job separated by separator sheets (FIG. 2). Thus, the embodiments herein provide the user with the ability to input multiple quantities (and quantity identifiers) to allow a printing engine to automatically insert separator sheets between different quantities of the same print job, without additional user intervention.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method comprising:
receiving instructions to print a plurality of quantities of a single print job;
sequentially printing each of said quantities; and
automatically inserting a separator sheet between each of said quantities.

2. The method according to claim 1, wherein said printing is performed utilizing a single printing engine.

3. The method according to claim 2, wherein said single printing engine comprises:
at least one marking engine; and
a single output.

4. The method according to claim 1, wherein said receiving of said instructions comprises inputting all of said quantities before said sequentially printing of said quantities begins.

5. The method according to claim 1, wherein said sequentially printing of said single print job and said automatically inserting of said separator sheet produce a single output having all of said quantities of said print job separated by separator sheets.

6. The method according to claim 1, wherein said separator sheet comprises identifying information.

7. The method according to claim 1, wherein said separator sheet comprises a distinguishable sheet from sheets used for said printing.

8. A method comprising:
receiving instructions to print a plurality of quantities of a single print job, wherein said quantities comprise different numbers of copies of said single print job, and wherein said single print job comprises at least one document;
printing a first quantity of said quantities;
automatically inserting a separator sheet after said printing of said first quantity; and
repeating said printing and said automatically inserting of said separator sheet for all remaining quantities.

9. The method according to claim 8, wherein said printing is performed utilizing a single printing engine.

10. The method according to claim 9, wherein said single printing engine comprises:
at least one marking engine; and
a single output.

11. The method according to claim 8, wherein said receiving of said instructions comprises inputting all of said quantities before said printing of said quantities begins.

12. The method according to claim 8, wherein said sequentially printing of said single print job and said automatically inserting of said separator sheet produce a single output having all of said quantities of said print job separated by separator sheets.

13. The method according to claim 8, wherein said separator sheet comprises identifying information.

14. The method according to claim 8, wherein said separator sheet comprises a distinguishable sheet from sheets used for said printing.

15. A system comprising:
a graphic user interface adapted to receive instructions to print a plurality of quantities of a single print job; and
a printing engine in communication with said graphic user interface,
wherein said printing engine is adapted to sequentially print each of said quantities and automatically insert a separator sheet between each of said quantities.

16. The system according to claim 15, wherein said single printing engine comprises:
at least one marking engine; and
a single output.

17. The system according to claim 15, wherein said graphic user interface is adapted to receive all of said quantities before said printing engine sequentially prints said quantities.

18. The system according to claim 15, wherein by sequentially printing said single print job and automatically inserting said separator sheet, said printing engine produces a single output having all of said quantities of said print job separated by separator sheets.

19. The system according to claim 15, wherein said separator sheet comprises identifying information.

20. The system according to claim 15, wherein said separator sheet comprises a distinguishable sheet from sheets used for said printing.
